(19) United States
(12) Patent Application Publication
(10) Pub. No.: US 2007/0147462 A1
(43) Pub. Date: Jun. 28, 2007

(54) RAPID HEATING AND COOLING FURNACE

(76) Inventors: Dale R. Wilcox, Penfield, NY (US); Richard M. Vernon, Rochester, NY (US)

Correspondence Address: HISCOCK & BARCLAY, LLP, 2000 HSBC PLAZA, 100 Chestnut Street, ROCHESTER, NY, 14604-2404, US

(21) Appl. No.: 11/613,538

(22) Filed: Dec. 20, 2006

Related U.S. Application Data
(60) Provisional application No. 60/753,568, filed on Dec. 23, 2005.

(51) Int. Cl. F27D 9/00

(52) U.S. Cl. 373/113

(57) ABSTRACT

The invention includes a furnace having a rapid heating and cooling cycle. The rapid heating is achieved by any suitable process, such as induction heating. The cooling is achieved by recirculating a working fluid through a heat exchanger that is outside the furnace. The working fluid is moved using a high-vacuum compatible impellor assembly having a vacuum sealed housing and a motor outside the housing. A ferrofluidic feed-through transfers torque from the motor to the fan while maintaining the hermetic seal.

### CROSS-REFERENCE TO RELATED APPLICATIONS

This application claims priority from U.S. Provisional Patent Application Ser. No. 60/753,568, filed Dec. 23, 2005, which is herein incorporated by reference.

### FIELD OF THE INVENTION

This invention relates to rapid heating and cooling furnaces. More particularly, this invention relates to furnaces that move a sealed atmosphere through a heat exchanger.

### BACKGROUND OF THE INVENTION

One trend in manufacturing is that of lean manufacturing, which requires a vacuum furnace having a small footprint and a rapid cycle time. The rapid heating of the furnace may be accomplished using induction heating systems such as those described in U.S. Pat. No. 6,649,887 to Budinger and U.S. Pat. No. 6,861,629 to Dahake, et al. However, a vacuum furnace having a rapid cooling function is needed. Conventionally, a vacuum furnace system is cooled by introducing a high pressure atmosphere at 2-20 bar and force cooling the system, recirculating the gas. Such a high pressure system requires an expensive pressure chamber. Therefore a simpler, less expensive cooling apparatus is needed that is high-vacuum compatible (at least 5×10⁻⁴ TORR).

Conventional blower systems are typically loud and contain lubricants that may contaminate the atmosphere being moved. It is important to control the contents of the atmosphere in a vacuum furnace so as to not adversely affect the material properties of the work piece. Further, convention blower systems that are high-vacuum compatible tend to be expensive. Even further, conventional blower systems generally focus on cooling efficiency rather than speed. Therefore a blower system for a vacuum furnace that is high-vacuum compatible, is substantially contaminate free, has a lower sound level—preferably less than 120 db, has a lower cost, and has a rapid cooling speed is needed.

### SUMMARY OF THE INVENTION

The invention comprises, in one form thereof, a furnace having a rapid heating and cooling cycle. The rapid heating is achieved by any suitable process, such as induction heating. The cooling is achieved by backfilling the furnace with a partial pressure of an inert gas, such as Argon, and recirculating the atmosphere through a heat exchanger that is outside the furnace. The atmosphere is moved using a high-vacuum compatible impellor having a vacuum sealed housing and a motor outside the housing. A ferrofluidic feed-through transfers torque from the motor to the fan while maintaining the hermetic seal.

In one form, the invention includes a rapid heating and cooling furnace, having a furnace with a workpiece chamber; and a rapid cooling system in fluid communication with the workpiece chamber. The rapid cooling system includes an impellor assembly having a vacuum sealed housing; a fan situated within the housing; a motor external to the vacuum sealed housing; and a driveshaft feed-through coupling the motor to the fan and having a ferrofluid seal at an interface between the driveshaft feed-through and the vacuum sealed housing.

In another form, the invention includes a method of treating a workpiece in a vacuum furnace. The method comprises the steps of heating a workpiece in a furnace; recirculating a working fluid through a heat exchanger at a high rate; and driving the working fluid with an impellor assembly having a vacuum sealed housing, a fan situated within the housing, a motor external to the vacuum sealed housing, and a driveshaft feed-through coupling the motor to the fan and having a ferrofluid seal.

In another form, the invention includes a high vacuum compatible impellor assembly in a rapid cooling system of a vacuum furnace. The impellor assembly includes a housing cover connected to a housing with an o-ring therebetween and a plurality of fasteners to form a high vacuum compatible seal; a fluid inlet and a fluid outlet each having a connecting means forming a fluid seal with a fluid passageway; a fan situated within the housing between the fluid inlet and the fluid outlet; and a ferrofluidic feed-through connecting the fan to an external motor while maintaining the high vacuum compatible seal of said impellor assembly.

An advantage of the present invention is that the impellor system is high-vacuum compatible while being cost competitive, it is compact and light weight, it has a lower operational sound level than the conventional art, it does not use oil lubrication that may contaminate the atmosphere being moved, and it has a minimal number of flow restrictions. Particularly, the invention provides faster cooling of the furnace than conventional blower systems.

### BRIEF DESCRIPTION OF THE DRAWINGS

The present invention is disclosed with reference to the accompanying drawings, wherein:

FIG. 1 is a schematic of a vacuum furnace system of the present invention;

FIG. 2A is an isometric view of the impellor of FIG. 1;

FIG. 2B is a disassembled view of the impellor of FIG. 1;

FIG. 2C is a side view of the impellor of FIG. 1;

FIG. 3 is a cross-sectional view of the ferrofluidic feed through of FIG. 2A; and

FIGS. 4A and 4B are conceptual drawings of heat exchangers.

Corresponding reference characters indicate corresponding parts throughout the several views. The example set out herein illustrates one embodiment of the invention but should not be construed as limiting the scope of the invention in any manner.

### DETAILED DESCRIPTION

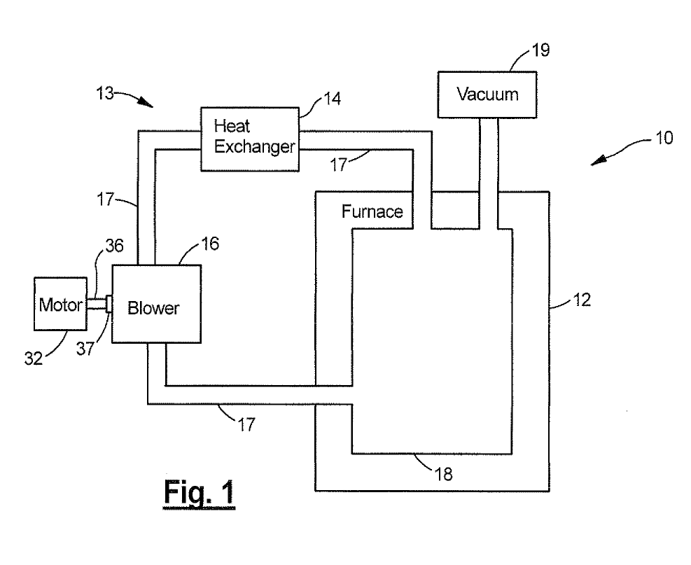

Referring to FIG. 1, there is shown the furnace system of the present invention. The system 10 includes a furnace 12 and a cooling system 13. The cooling system 13 includes a heat exchanger 14, an impellor 16, and fluid passageways 17. The furnace 12 has a workpiece chamber 18 and a rapid heating function such as the induction furnaces described in U.S. Pat. Nos. 6,649,887 and 6,861,629, both of which are hereby incorporated by reference. The furnace 12 may be a vacuum furnace with a vacuum 19 in fluid communication with the workpiece chamber. The vacuum 19 is preferably capable of reducing the pressure in the workpiece chamber 18 to a high vacuum environment, such as 5×10⁻⁴ TORR or lower pressure. The workpiece chamber 18 is back-filled with a gas that is circulated through the heat exchanger 14 at a high flow rate to provide the cooling function for the furnace 12. The gas is preferably an inert gas, such as Argon, and the workpiece chamber 18 contains the gas at a pressure of about 760 TORR in a particular embodiment.

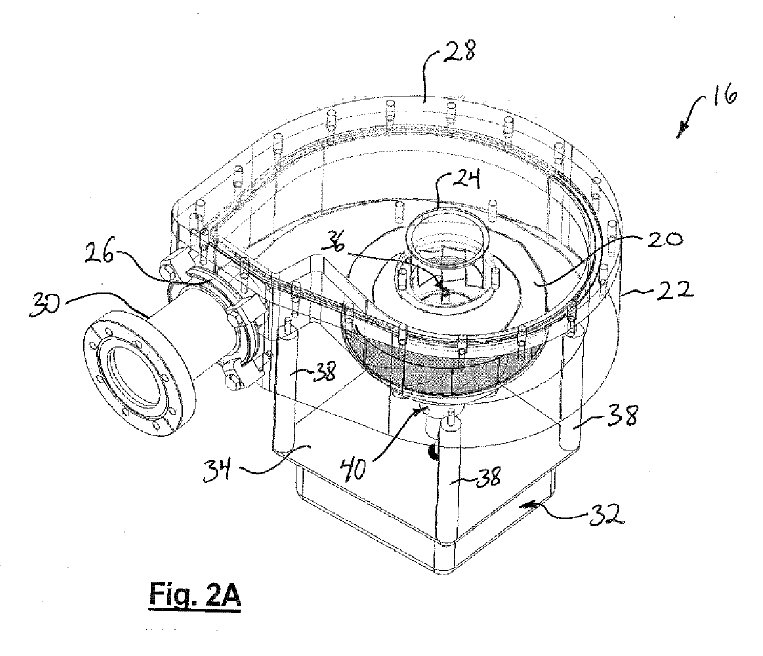

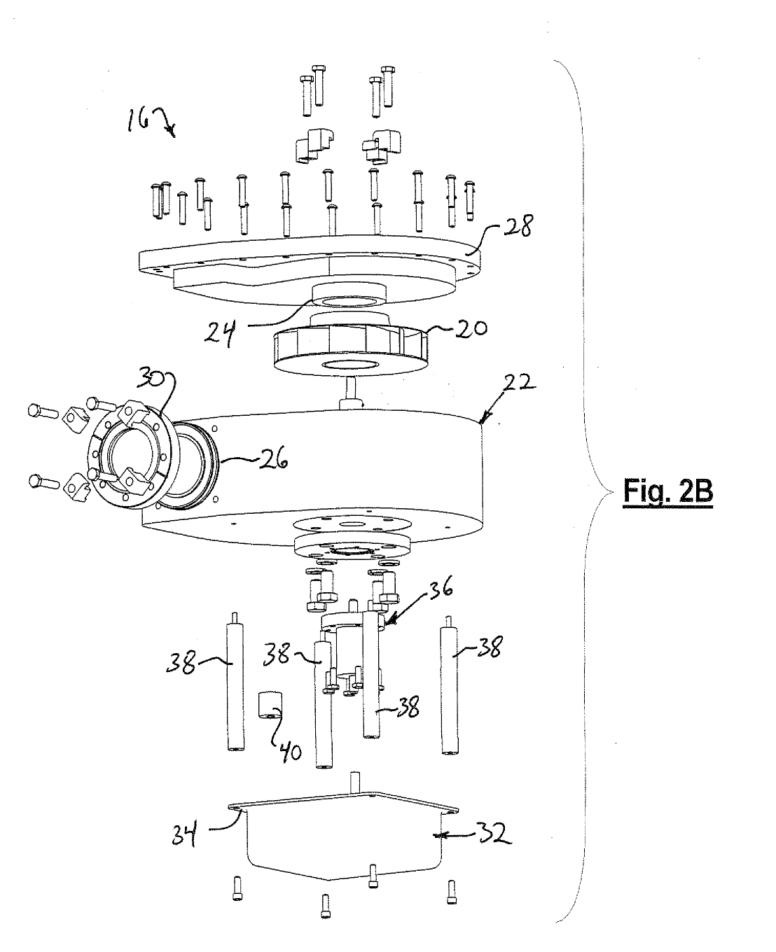

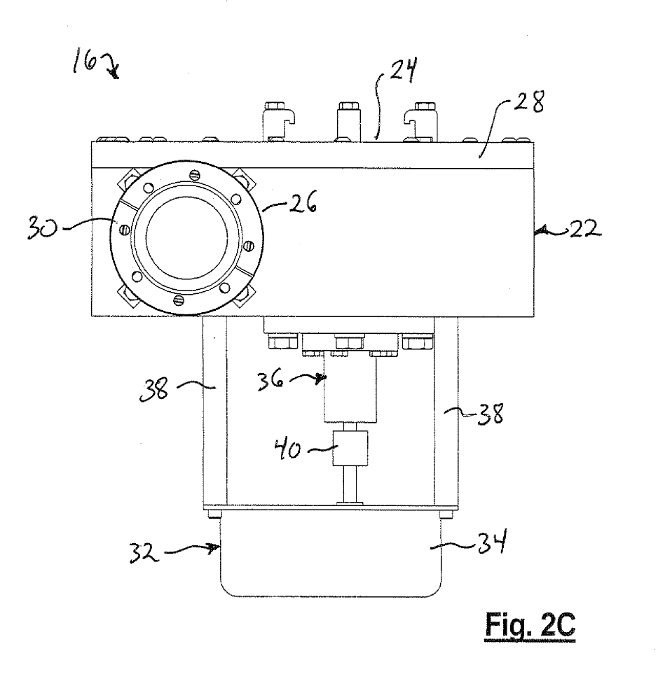

Referring now to FIGS. 2A-2C, the impellor 16 drives the circulation of the gas and includes a fan 20, a housing 22, a fluid inlet 24, and a fluid outlet 26. In the illustrated embodiment, the fan 20 is a turbocharger style compressor blade such the one sold with the G1G170 Series Combustion Air Blower sold by EBM-Papst Inc, which is rated to 362 cfm and 5650 rpm. The fan material is aluminum with a surface resistance of less than 10⁹ and it is dynamically fine-balanced. The fan illustrated and detailed herein is by way of example. Alternative fan designs may also be suitable. The fan 20 can preferably overcome the back pressures of moving the gas through tubes on the order of about 4-inches in diameter.

The housing normally included with the G1G170 blower is not high-vacuum compatible and it is therefore replaced by the custom housing 22, which can preferably sustain at least a 5×10⁻⁴ TORR vacuum. The fan 20 draws gas through the fluid inlet 24 and outputs the gas into the housing 22 and through the fluid outlet 26, however, the impellor may be configured to run in the opposite direction. A housing cover 28 engages the housing 22 with an o-ring therebetween and a plurality of fasteners to form a sufficient seal. In the illustrated embodiment, 20 fasteners are used. The housing 22 is configured to have a minimum of flow restrictions. The fluid inlet 24 and the fluid outlet 26 are connected to the tubing of the system 10 by any suitable standard connection, such as a CF or QF connection an ISO 63 connection, or using standard o-rings. An adaptor 30 may be used with either the fluid inlet 24 or the fluid outlet 26 to convert between connection types. In an alternative embodiment, the impellor 16 is in an in-line configuration to eliminate the 90° direction change of the gas stream in the current embodiment.

A motor 32 is enclosed in a separate motor housing 34 and connected to the fan 20 by a driveshaft feed-through 36 with a multiple-stage ferrofluidic seal at the interface 37 between the feed-through 36 and the housing 22. In the current embodiment, the motor 32 is a brushless DC motor with integrated electronics and an external rotor, such as the one provided with the G1G170 Series Combustion Air Blower sold by EBM-Papst Inc. The separate motor housing 34 has the advantage of removing the motor 32 from the high gas flow rates and possibly hostile gasses inside the housing 22 and also separating the lubricants and debris from the motor from the cooling gas stream. The motor housing 34 is supported by standoffs 38 that are attached to the housing 22. A flexible shaft coupling 40 connects the driveshaft of the motor 32 to the feed-through 36 to allow easier alignment between the driveshaft of the motor 14 and the feed-through 36 and to reduce the initial torque to the feed-through 36 and the fan 20.

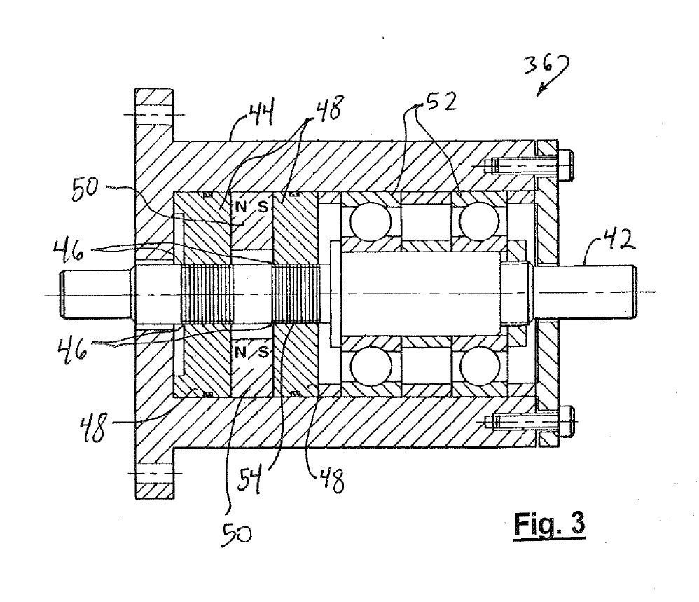

The ferrofluidic feed-through 36 is best shown in FIG. 3. Ferrofluidic feed-throughs, such as those made by Ferrotec Corporation, use a combination of ferrofluids (magnetic fluids) and magnets to provide a hermetic seal while allowing the shaft to rotate. The ferrofluid is retained in a ring between the casing and the central shaft by a magnetic field. The fluid properties of the ferrofluid allow the shaft to rotate at high speeds while the magnetic field maintains the density of the fluid, preventing the passage of gas therethrough. Particular ferrofluidic feed-throughs are described in detail in U.S. Pat. No. 6,543,782 to Rosensweig, et al. and U.S. Pat. No. 6,857,635 to Li, et al., both of which are hereby incorporated by reference.

The illustrated feed-through 36 includes a central shaft 42, a casing 44, ferrofluid 46, pole pieces 48, a magnet 50, and ball bearings 52. The magnet 50 controls the viscosity of the ferrofluid 46 such that the viscosity is high enough to prevent gas from passing through the hermetic seal. Ridges 54 in the portions of the shaft 42 that pass through the ferrofluid 46 provide the interface between the ferrofluid 46 and the shaft 42. The ferrofluid 46 and the bearings 52 are enclosed within the casing 44 and the feed-through does not require the addition of lubrication once installed. Thus, there is no lubrication within the housing 22 to contaminate the atmosphere being moved by the impellor 16. The casing 44 sealingly engages the underside of the housing 22 so that the shaft 42 engages the fan 20 and the flexible shaft coupling 40. The magnet 50 and pole pieces 48 cooperate to provide high intensity magnetic flux lines that line up with the ridges 54. The magnetic flux lines hold the ferrofluid 46 in engagement with the ridges 54.

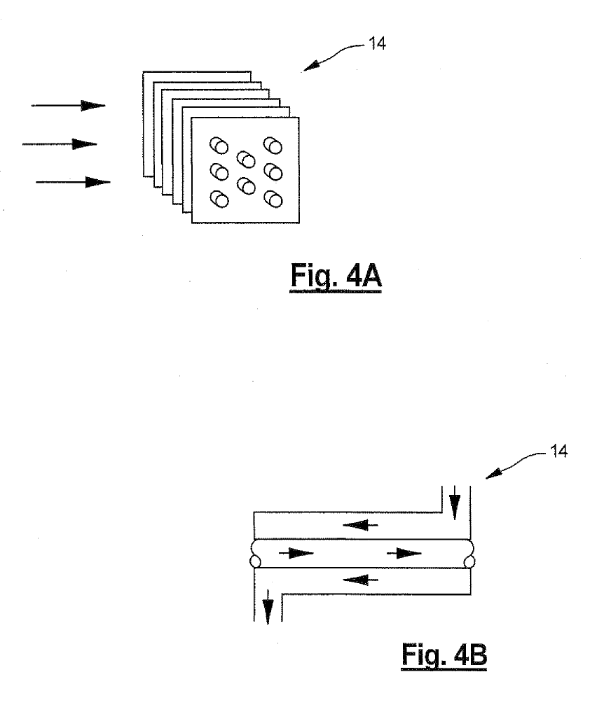

The heat exchanger 14, shown conceptually in FIGS. 4A and 4B, is any heat exchanger for cooling a high flow rate gas stream, such as a compact cross flow heat exchanger with fins as shown in FIG. 4A or a concentric tube heat exchanger as shown in FIG. 4B. In the cross flow heat exchanger, the gas transfers heat to the large surface area of the fins. A coolant flowing through the tubes, transverse to the gas flow direction, carries the heat to a heat dissipation portion (not shown). In the concentric tube, and similarly in a shell-and-tube heat exchanger, the gas flows through the central tube or tubes while a coolant flows through the outer tube or shell. A further example of a heat exchanger is a parallel plate heat exchanger, which comprises a plurality of parallel plates that define fluid passages. The gas and the coolant flow through alternating fluid passages with the coolant passing in a transverse direction to the process gas. The heat exchanger 14 is preferably made of materials that are substantially inert to the components of the gas stream and is sealed to prevent contamination of the gas stream. The heat exchanger 14 is also preferably high vacuum compatible.

In use, the workpiece is rapidly heated, such as by induction heating. Once the heating process is deactivated, the heat exchanger is activated, and a voltage is supplied to the motor 32. The driveshaft of the motor 14 applies a torque to the flexible shaft coupling 40, which, in turn, applies the torque to the central shaft 42 of the feed-through 36. The ferrofluid 46 allows the shaft 42 to rotate while providing a multi-stage hermetic seal around the shaft 42. The central shaft 42 rotates the fan 20, which draws the atmosphere in the furnace 12 through the heat exchanger 14, into the fluid inlet 24, and into the housing 22. The atmosphere, having been cooled by the heat exchanger, is exhausted through the fluid outlet 26 into the furnace 12. The atmosphere is continually recirculated at a high rate until the desired temperature is reached in the furnace 12 or the workpiece. The heat exchanger is deactivated and the voltage to the motor 14 is cut off to end the cycle and a new heating and cooling cycle is commenced. After the work piece has completed the desired number of cycles, it is replaced and the cycling continues.

In the case that the furnace 12 is a vacuum furnace that heats the workpiece in the absence of an atmosphere, the workpiece chamber 18 is backfilled with an working fluid, such as an inert gas, prior to the cooling cycle. The gas may be introduced through the ductwork (fluid passageways 17) in communication with the impellor assembly 16 or by a separate backfilling system.

It should be noted that, in the cooling function of the furnace system of the present invention, the focus is on cooling speed, not cooling efficiency. Whereas conventional cooling systems strive for a high cooling efficiency, the cooling system of the present invention strives for a higher cooling rate with less regard for efficiency.

The fan and motor designs and specifications are provided by way of example. One skilled in the art will note that different ductwork configurations, heat exchangers, and furnace sizes may require variations in the fan and motor details in order to provide sufficient cooling gas flow. A configuration with a larger furnace or ductwork with higher backpressure may require a more powerful fan and motor combination.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A rapid heating and cooling furnace, comprising:
a furnace having a workpiece chamber; and
a rapid cooling, system in fluid communication with the workpiece chamber, comprising:
an impellor assembly having a vacuum sealed housing;
a fan situated within the housing;
a motor external to the vacuum sealed housing; and
a driveshaft feed-through coupling the motor to the fan and having a ferrofluid seal at an interface between the driveshaft feed-through and the vacuum sealed housing.

2. The furnace of claim 1, further comprising a flexible shaft coupling connecting the driveshaft feed-through to a driveshaft of the motor.

3. The furnace of claim 1, the furnace having a rapid heating system.

4. The furnace of claim 3, the rapid heating system comprising an induction heating system.

5. The furnace of claim 1, the rapid cooling system further comprising a fluid passage communicating a working fluid between the workpiece chamber and the impellor assembly.

6. The furnace of claim 5, the working fluid being an inert gas.

7. The furnace of claim 5, the working fluid being Argon.

8. The furnace of claim 5, the rapid cooling system further comprising a heat exchanger in-line with the fluid passage.

9. The furnace of claim 1, said furnace being a vacuum furnace.

10. The furnace of claim 9, the vacuum sealed housing and said driveshaft feed-through being sufficient to maintain a high vacuum of 5×10⁻⁴ TORR or lower pressure.

11. The furnace of claim 1, the ferrofluid seal comprising multiple seal stages.

12. The furnace of claim 1, the housing having a minimum of flow restrictions and comprising:
a housing cover connected to the housing with an o-ring therebetween and a plurality of fasteners to form a high vacuum compatible seal; and
a fluid inlet and a fluid outlet each having a connecting means forming a vacuum seal with a fluid passageway.

13. The impellor assembly of claim 12, further comprising an adaptor for connecting a fluid passageway to the fluid inlet or the fluid outlet wherein the fluid passageway has a different connection configuration than the fluid inlet or the fluid outlet.

14. A method of treating a workpiece in a vacuum furnace, comprising the steps of,
a) heating a workpiece in a furnace;
b) recirculating a working fluid through a heat exchanger at a high rate; and
c) driving the working fluid with an impellor assembly having a vacuum sealed housing, a fan situated within the housing, a motor external to the vacuum sealed housing, and a driveshaft feed-through coupling the motor to the fan and having a ferrofluid seal.

15. The method of claim 14, the furnace being a vacuum furnace.

16. The method of claim 15, further comprising the step of backfilling the vacuum furnace with the working fluid after said workpiece heating step.

17. The method of claim 14, said workpiece heating step comprising the step of rapidly heating the workpiece through induction heating.

18. The method of claim 14, the working fluid being an inert gas.

19. The method of claim 14, the working fluid comprising Argon.

20. The method of claim 14, the vacuum sealed housing and the driveshaft feed-through capable of maintaining a high vacuum of 5×10⁻⁴ TORR or lower pressure.

21. A high vacuum compatible impellor assembly in a rapid cooling system of a vacuum furnace, the impellor assembly comprising:
a housing cover connected to a housing with an o-ring therebetween and a plurality of fasteners to form a high vacuum compatible seal;
a fluid inlet and a fluid outlet each having a connecting means forming a vacuum seal with a fluid passageway;
a fan situated within the housing between the fluid inlet and the fluid outlet; and
a ferrofluidic feed-through connecting the fan to an external motor while maintaining the high vacuum compatible seal of said impellor assembly.

22. The impellor assembly of claim 21, further comprising an adaptor for connecting a fluid passageway to the fluid inlet or the fluid outlet wherein the fluid passageway has a different connection configuration than the fluid inlet or the fluid outlet.

23. The impellor assembly of claim 21, the housing being configured with a minimum of flow restrictions.
